(19) United States
(12) Patent Application Publication
(10) Pub. No.: US 2006/0129700 A1
(43) Pub. Date: Jun. 15, 2006

(54) Bridging a local bus with a data network

(76) Inventor: Rajendra A. Bopardikar, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/008,874

(22) Filed: Dec. 9, 2004

(51) Int. Cl. G06F 3/00

(52) U.S. Cl. 710/2

(57) ABSTRACT

Disclosed are various exemplary embodiments concerning bridging a local bus, such as a Universal Plug and Play (UPnP) bus not typically visible to a public network, such as a local area network, wide area network, the Internet, etc., with such networks. Such bridging enables, among other things, rich usage scenarios for local bus devices when made generally available to a network. For example, in a digital home or digital office environment, providing network access to local bus devices, such as cameras, security devices, storage devices, etc., provides for many interesting synergistic uses of conventional network devices in combination with exposed local bus devices. Policies may be used to control exposure; for example, a local bus or its enclosing machine may have policies for controlling access. Or, a local network, e.g., a digital home or digital office, may also have policies to manage local bus exposure, such as to a broader network such as the Internet.

### FIELD OF THE INVENTION

The invention generally relates to recognizing devices on a local bus, and more particularly to bridging the local bus with a network by presenting devices of the local bus as devices on the network.

### BACKGROUND

Various bus environments provide for automatic discovery, configuration, control, and manipulation of devices within their environment.

These environments include, for example, buses local to a host such as the Universal Serial Bus (USB). A USB, as is well understood, consists of a single host controller and one or more USB devices, e.g., an appliance, instrument, machine or part thereof, computing device or component thereof, Personal Digital Assistant (PDA), telephone, camera, scanner, printer, microphone, video device, etc. attached to the USB. USB devices can be arranged as a tree-type graph of devices interconnected by USB hubs. When a device attaches to the USB, the host controller recognizes the addition and enumerates the new device, e.g., assigns the device a bus address and activates drivers as needed to integrate it into the host and/or its operating system.

These various environments also include, for example, networks such as wired and/or wireless networks that support protocols such as Universal Plug and Play (UPnP) over a TCP/IP (Transmission Control Protocol/Internet Protocol) or other protocol. As with the Universal Serial Bus (USB), a UPnP also environment also provides for discovery, configuration, control, etc. of machines, such as media centers, television displays, recording devices, appliances, etc., that are networked within the environment and supporting the UPnP protocol.

However, while there is some high-level similarity between USB and UPnP ability to discover and manage devices in their environments, local bus and network environments are very different, hence there is no cross-over between these environments. It would, however, be convenient if it were possible to automatically and/or transparently discover and control devices in one environment from the other.

### BRIEF DESCRIPTION OF THE DRAWINGS

The features and advantages of the present invention will become apparent from the following detailed description of the present invention in which:

FIG. 1 a system according to one embodiment.

FIG. 2 illustrates another system according to one embodiment.

FIG. 3 illustrates a flowchart according to one embodiment for creating a Virtual UPnP device for a device attached to a local bus.

FIG. 4 illustrates a suitable computing environment in which certain aspects of the invention may be implemented.

### DETAILED DESCRIPTION

The following discussion focuses, for expository convenience, on bridging the Universal Serial Bus (USB) with a network providing Universal Plug and Play (UPnP) services since USB and UPnP are well known environments. It will be appreciated by one skilled in the art, however, that the following description and principles may be applied to bridge virtually any local bus and network. Consequently, in description and claims that follow, the intent herein is to encompass broadly USB, UPnP and all other environments compatible with the teachings herein.

The reader is assumed familiar with both the USB and the UPnP specifications. However, if further information on USB is desired, one can access the following Universal Resource Locator (URL) “web” addresses: www-USB-org. If further information on UPnP is desired, once can access the following URL: www-UPNP-org. (Please note, to prevent inadvertent hyperlinks, periods in the preceding URLs were replaced with hyphens.) Given the assumption of familiarity with these specifications, the following description will not discuss the mechanics of USB or UPnP in great detail.

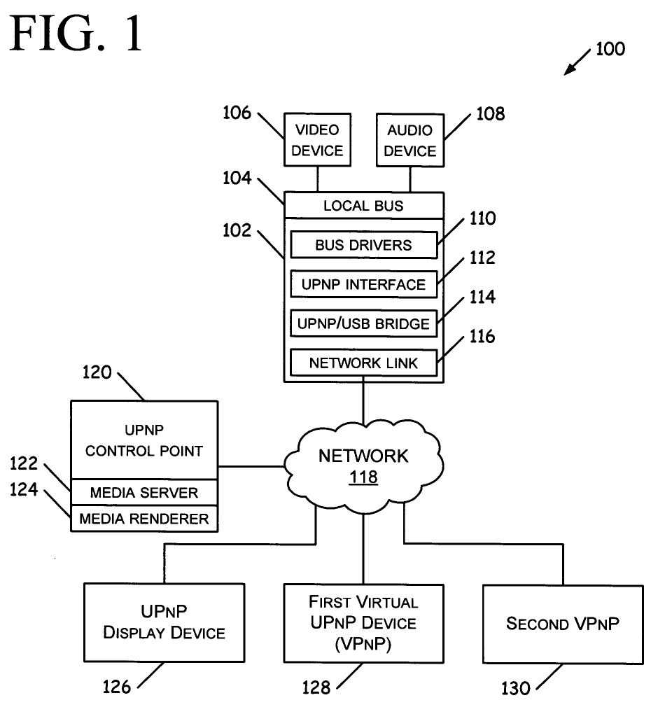

FIG. 1 illustrates a system 100 according to one embodiment. Shown are a machine 102, which may be any sort of computing device such as a personal computer, notebook computer, personal digital assistant (PDA), article of clothing, telephone, appliance, etc. that has a local bus 104 to which one or more devices 106, 108 may be attached. The devices illustrated devices 106, 108 are conventional video and audio devices, but this is for exemplary purposes only; any attachable device is contemplated.

It is assumed the local bus includes a Universal Serial Bus (USB) with the machine 102 as its host, but as discussed above, USB is presented as one example of many such buses that may be utilized as discussed herein. In the illustrated embodiment, associated with the local bus 104 are bus drivers 110 corresponding to drivers required to integrate the local bus and attached devices into a control program for the machine 102, for example to interface the local bus with an operating system (not illustrated) for the machine.

It will be appreciated that while the bus drivers are illustrated as a single block, this block may represent many different drivers. As is understood by one skilled in the art, when a device is attached to a local bus, such as the USB, a logical connection is established between the machine 102, e.g., the host, and the new device, e.g., devices 106, 108. Device attachment can be determined physically, e.g., by recognizing a drop in resistance or voltage on the bus, or logically depending on the bus environment. For USB, attached devices are “enumerated,” assigned communication addresses, and the logical connection that is then established is called a “Pipe.” It will be appreciated there may be varied data delivery modes for communicating with devices on the local bus. One such mode is isochronous data delivery, which refers to sending a stream of data with a timing is implied by its delivery rate. Isochronous transfers provide periodic continuous communication between a host and a device.

When the logical connection is established, the host obtains various characteristics about the device, such as its communication requirements and descriptions of services offered by the device. For example, for a USB device attachment, the host issues a “Get_Descriptor” request to identify the device's “endpoints.” Once this inspection is complete, the host may then load drivers 110 as appropriate for the device and/or its endpoints. For some devices, such as Human Interface Devices or HIDs in a Microsoft Windows operating system, e.g., mouse, joystick, keyboard, etc., do not need to supply drivers as they can rely on generic HID drivers provided by the operating system. Other devices may need high-level software (not illustrated), such as a custom user interface program or one provided by the operating system to utilize or fully utilize an attached device that has been attached. For example, the illustrated video device 106 may utilize the basic video application software typically bundled with an operating system, or one may utilize custom software that typically provides enhanced functionality and/or performance.

Once the local bus device 106, 108 has been recognized by the machine 102, in the illustrated embodiment, the illustrated Universal Plug and Play (UPnP) interface 112 (e.g., conventional UPnP interface between a machine and/or it's operating system and a UPnP enabled network), UPnP/USB Bridge 114 and network interface 116 may then be used as discussed below to present local bus devices, e.g., devices 106, 108 as Virtual UPnP (VPnP) devices 128, 130. As noted above, UPnP is presented for exemplary purposes and other device discovery and configuration environments are contemplated.

As will be appreciated by one skilled in the art, the UPnP architecture enables discovery and control between UPnP devices on a network independent of particular operating systems, programming languages, or physical network connections. UPnP technology is currently based on existing Internet standards and languages such as TCP (Transmission Control Protocol), HTTP (HyperText Transport Protocol) and XML (eXtensible Markup Language), SOAP (Simple Object Access Protocol), and is applicable to future protocols as they arise.

When a UPnP device such as the illustrated display device 126 enters a network, e.g., establishes a wired or wireless communicative coupling with network 118, the device advertises itself to the network to alert other UPnP devices of its arrival. Typically a UPnP device uses the Simple Service Discovery Protocol (SSDP) to advertise its presence and services to other interested machines on the network. The device may achieve this by multicasting its advertisement to a standard address and port to which other entities listen for such advertisements. One particular class of machine listening for such advertisements is referred to as a UPnP control point 120. Control points may operate as aggregators of service information; that is, in addition to other services that the control point may offer, control points may track capabilities currently available within a network.

Control points may passively listen for and track advertisements from UPnP devices. Alternatively, SSDP provides for a control point to search for devices or services of interest in the network by multicasting a search message identifying a device or service type of interest. For example, in one embodiment, a control point may issue a “M-Search” or equivalent type of discovery request. Responses from devices contain discovery reply messages equivalent to advertisements from devices newly attached to the network, but typically responses to a search request are directed to the requester, e.g., unicast to the control point rather than multicast to the network.

Similar in concept to discovering devices newly attached to the local bus 104, after the initial discovery phase for a UPnP device newly attached to the network 118, a control point or other interested device only has basic information about the newly attached device. Thus, following initial discovery is a description determination stage in which the newly attached device may provide detailed information about itself to other interested devices. As will be understood by one skilled in the art, similar in concept to the USB “Get_Descriptor” operation for discovering details for devices attached to the local bus, under UPnP, a control point or other interested device may send a “GET” request to a “DescriptionURL” provided by the device during initial discovery. The URL points to an XML file describing the device in detail.

The device description may include various data about the device, such as device name, device type, manufacturer, manufacturer's Uniform Resource Locator (URL), model information, such as model name and model number, serial number, URL for the model, Universal Product Coe (UPC), icon or image associated with the device, embedded services and/or devices offered by the device, etc. The description include standard UPnP entries required to be present, and may also indicate additional services offered by the device. The description typically lists all services offered by the device and how to use/access them, thus the devices are self-describing in their capabilities. As noted above, the description may also indicate embedded physical and/or logical devices and services provided by such sub devices. If a device, such as a control point or other interested device, wants more information about an entry in the device description, it can request a Service Description to get more information.

Once a control point or other interested device has the device's description, it may then control the device according to the description, e.g., a device may invoke services offered by the device and otherwise interact with the device. As will be understood by one skilled in the art, SOAP messages (typically XML over HTTP) are used to describe the invocation of services offered by a device and return of information and/or errors by an invoking device. But, it will be appreciated the illustrated embodiments are not limited to SOAP, XML, or HTTP, and instead any other language and/or protocol compatible with the teachings herein may be used instead.

Given the USB and UPnP environments, a Virtual UPnP (VPnP) device may be defined with respect to and USB device on the local bus, for example, for the illustrated Video device 106.

As will be understood by one skilled in the art, UPnP provides an “AV” (audio-visual) architecture that includes a “media server” and “media renderer” that can be controlled by a control point 120 so one may render content on a particular rendering device. While UPnP AV speaks of a separate control point, media server and media renderer, it is understood that a single device may contain some or all of them. For example, the illustrated control point 120 is shown with internal modules 122, 124 corresponding to an integrated media server and media renderer. Were they not integrated, the control point could engage in a conventional UPnP search for these devices in the network 118. In one embodiment, not illustrated, the control point, media server and media renderer may all be integrated in machine 102.

Once the media server and media renderer are located, UPnP AV provides various functionality, including enumeration of available content for these devices, querying the media server and media renderer for available transfer protocols and media formats, and controls for accessing content, e.g., by another device on the network such as UPnP display device 126.

Thus, when local bus 104 Video Device 106 is attached and recognized as discussed above, in the illustrated embodiment, a UPnP/USB bridge 114 within the machine 102 may be used to define a first Virtual UPnP device 128. Similarly, when local bus audio device 108 is attached, a second VPnP device 130 may be defined. Each of these virtual devices 128, 130 may be advertised on the network 118 as if they are typical UPnP devices. In the illustrated embodiment, bridge 114 is communicatively coupled with both the USB and UPnP environments and operates to translate commands, control, data, etc. between the two environments.

It will be appreciated that various techniques may be employed to place the bridge between the two environments, including integrating the bridge within bus drivers 110, replacing the bus drivers entirely, operating as parallel drivers monitoring the bus, operating as a shim between the bus drivers and an operating system (not illustrated) for the machine 102 (e.g., intercepting and modifying communication between the operating system and bus drivers, or otherwise appearing to be the bus drivers to the operating system), instantiating the bridge as drivers for a second virtual local bus providing the same devices as identified on the local bus, etc. One skilled in the art will appreciate any number of techniques may be employed at a low level to implement the bridge between the exemplary USB and UPnP environments.

Thus, assuming the local bus Video Device 106 is recognized by the UPnP bridge 114 when the Video Device is attached to the local bus, the bridge may then determine characteristics of the device. It will be appreciated that determining characteristics of the device is somewhat dependent on the nature of the bridge, e.g., if the bridge is operating as a replacement driver for the bus drivers 110, then the bridge discovers the Video Device's characteristics directly. Or, if the bridge operates as a separate driver, it may nonetheless subscribe to receiving USB bus notifications, receive notification of the Video Device's attachment and query the device directly, e.g., issue a USB “Get_Descriptor” operation or otherwise access information about the device at its specially designated pipe at endpoint zero. Or, if the bridge is operating as a shim, it can monitor communication between the bus driver 110 and the operating machine (not illustrated) for the machine and discern details in such manner.

Once the characteristics of the Video Device 106 have been identified, the UPnP/USB Bridge 114 can construct a UPnP advertisement for a Virtual UPnP Device 128 corresponding to the Video Device 106, where the advertisement identifies the discovered various features of the Video Device 106. This advertisement, when put to the network 118 may be received by a control point such as the illustrated control point 120 containing the integrated media server 122 and media renderer 124, or by some other interested device. The control point or other interested device may then utilize the first VPnP device in accord with the UPnP environment, while in the background the UPnP/USB Bridge 114 operates to translate commands, control, data, etc. between the physical local bus Video Device 106 and the controlling device accessing the first VPnP device.

Thus, in the context of the above discussion, consider the Universal Serial Bus Device Class Definition (USB DCD) for Video Devices, Revision 1.0a dated Nov. 3, 2003 from the USB Implementers Forum, and UPnP RenderingControl: 1 (UPnP RC)Service Template Version 1.01 For Universal Plug and Play Version 1.0 (Standardized DCP) dated Jun. 25, 2002. The USB DCD describes an exemplary “Brightness Control” component within a “Processing Unit” that has discoverable attributes that may be manipulated by host software to affect the brightness of video being streamed. (See pages 6, 55, 88). Similarly, in the UPnP RC, defined, for example, are GetBrightness and SetBrightness (see pages 22-23). Thus, as discussed above, the UPnP/USB Bridge 114 may translate Get Brightness and SetBrightness actions from a UPnP control point into corresponding USB CDC control requests for a USB video device.

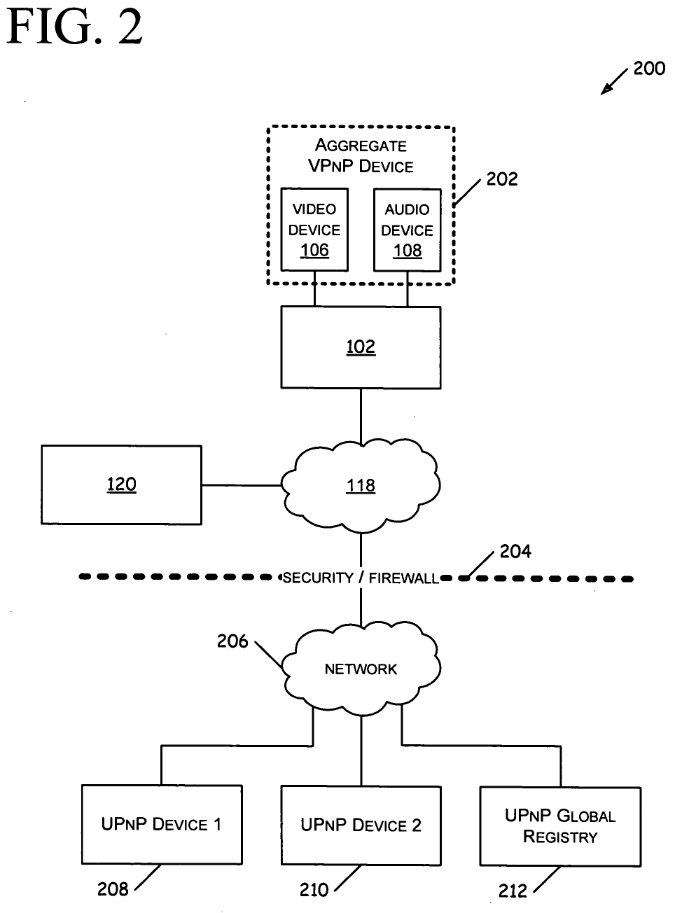

FIG. 2 illustrates another system according to one embodiment. As illustrated in FIG. 2, a Virtual UPnP (VPnP) device, such as FIG. 1 device 128, is not limited to the physical characteristics of a distinct device of the local bus 104, e.g., there is no need for a 1:1 mapping between the VPnP Video device 128 and local bus Video Device 106.

Instead, for example, as illustrated, the Video 106 and Audio 108 devices discussed above with respect to FIG. 1 can be combined into an Aggregate Virtual UPnP Device 202, where this aggregate device is a logical aggregation of the various features of the sub-devices 106, 108. It will be appreciated that since UPnP devices may contain many different features, if two aggregated devices have similar or identical features or services, the Aggregate Virtual UPnP Device may be configured to provide both service or to choose one over the other. For example, it may be that the video device has basic audio input capabilities inferior to that offered by the Audio device 108. The Aggregate Virtual UPnP Device 202 may then offer both input options, since, for example, if network bandwidth becomes constrained, it may be beneficial to switch to the inferior input option if that option results in a decrease in required bandwidth.

Also illustrated is a security barrier 204, such as one that may be available through use of a firewall or other security device for preserving the security of the network 118 from an external network 206. For example, a typical scenario is the network 118 corresponds to an internal home network or corporate LAN and the other network 206 corresponds to the Internet or other network having devices attached thereto not under the control of an administrator of the internal network 118. The security barrier prevents malicious activity from devices of the external network. In the illustrated embodiment, however, it is contemplated that devices of the internal network 118, such as the UPnP and VPnP devices 128-130 of FIG. 1 and the Aggregate Virtual UPnP Device 202, may be advertised to the external network 206.

As with any UPnP environment, a conventional global UPnP Registry 212 may record such advertisements from the local network 118, and external network UPnP devices, such as FIG. 2 devices 208, 210 may utilize the advertised UPnP and VPnP devices 128-130 of FIG. 1 and the Aggregate Virtual UPnP Device 202. In one embodiment, to facilitate propagating services of the UPnP and VPnP devices of the internal network 118 to the external network 206, while maximizing security, the security barrier 204, e.g., a firewall, may act as a middleman or proxy for the internal devices. The security barrier, in one embodiment, transcodes protocol data translations to make it appear as if the security barrier 204 were the actual and virtual UPnP devices of the internal network 118.

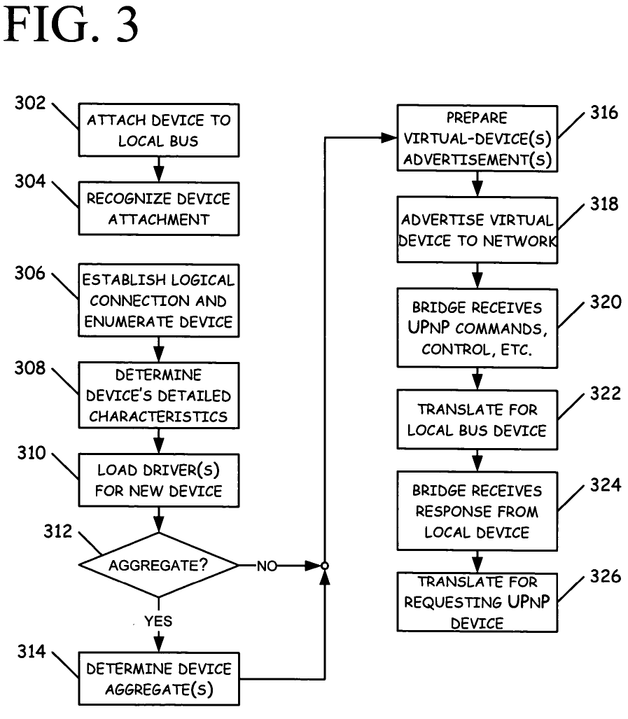

FIG. 3 illustrates a flowchart according to one embodiment for creating a Virtual UPnP device for a device attached to a local bus, such as the FIG. 1 local bus 104, a Universal Serial Bus (USB), or the like.

After attaching 302 a device to local bus of a host, the attachment is recognized 304. As discussed above, depending on the nature of the local bus, various techniques may be used to recognize device attachment. Once the physical connection of the device is recognized, a logical connection is established 306 between the host and the new device. Establishing the logical connection includes enumerating the attached device, which includes assigning an address to the device and determining basic operational requirements of the devices, such as identifying what type of device has been attached to the local bus.

Once the device has been enumerated and basic information about the device determined, a subsequent operation is to determine 308 detailed device characteristics for the device, such as communication requirements and service descriptions. Once this is know, drivers may be loaded 310 as appropriate for the device and it's physical and/or logical sub-devices (if any).

In one embodiment, a check may be performed to determine if 312 aggregation is desired. For example, recognized devices may be analyzed to see how they may be logically combined into an Aggregate Virtual UPnP Device. Based on devices recognized on the local bus, within the UPnP environment, and any other buses and/or environments if any, various permutations for combining the devices may be determined 314. It will be appreciated that various conventional lookup and database techniques, not discussed, may be applied to determine 314 potential virtual devices that may be constructed from recognized devices. Also, while aggregate devices may be determined, individual VPnP devices may also be defined for local bus devices.

Advertisements for the Virtual UPnP and/or Aggregate UPnP devices may be prepared 316. If a particular local bus device fails to have a characteristic required for properly completing a proper advertisement, it will be appreciated that default values may be used. In one embodiment, missing values may be derived from known values or discovered characteristics of the attached device. In another embodiment, a user may be queried to supply missing values, and/or to provide default system values.

As with introduction of a conventional UPnP device into a network environment, the advertisement for the Virtual UPnP and/or Aggregate UPnP devices may be advertised 318 to a network supporting UPnP, e.g., the FIG. 1 network 118. Once advertised, the bridge, e.g., FIG. 1 UPnP/USB Bridge 114 operates to receive 320 UPnP commands, control requests, etc. and translate 322 them accordingly into requests for the device of the local bus. The bridge also receives 324 responsive data, etc. from the local bus device and translates 326 the local bus device's response accordingly for the requesting UPnP device, e.g., a requesting control point or other device.

It will be appreciated that some embodiments use preferences and/or policies to control how aggregation is performed and how and under what circumstances a virtual device may be defined and utilized. It will be appreciated that there may be various levels of policy control, including use of global, regional, local and/or user specified preferences and/or policies. For example, policies (not illustrated) may be designed and applied to ensure a particular USB host is not dominated or otherwise monopolized through external use of the machines VPnP devices.

It will be appreciated that while the foregoing description has focused on bridging USB and UPnP networks by making USB devices virtually available on a network supporting UPnP, the converse may also be performed. That is, in one embodiment, the converse operations are performed so as to make a UPnP device of a network appear to a machine to be a device attached to a local bus of the machine. The teachings herein support such an embodiment, and such an embodiment may be useful, for example, when trying to use software and or hardware of the machine that was intended to only operate with local bus devices. By applying the teachings herein, a much broader spectrum of devices may now be utilized. It will be further appreciated that while the foregoing has focused on translating discovery and control information between the local device and the Virtual UPnP device, in various embodiments the bridge is also expected to translate interrupts and events generated by a local device into appropriate UPnP events for a UPnP control point or other interested device.

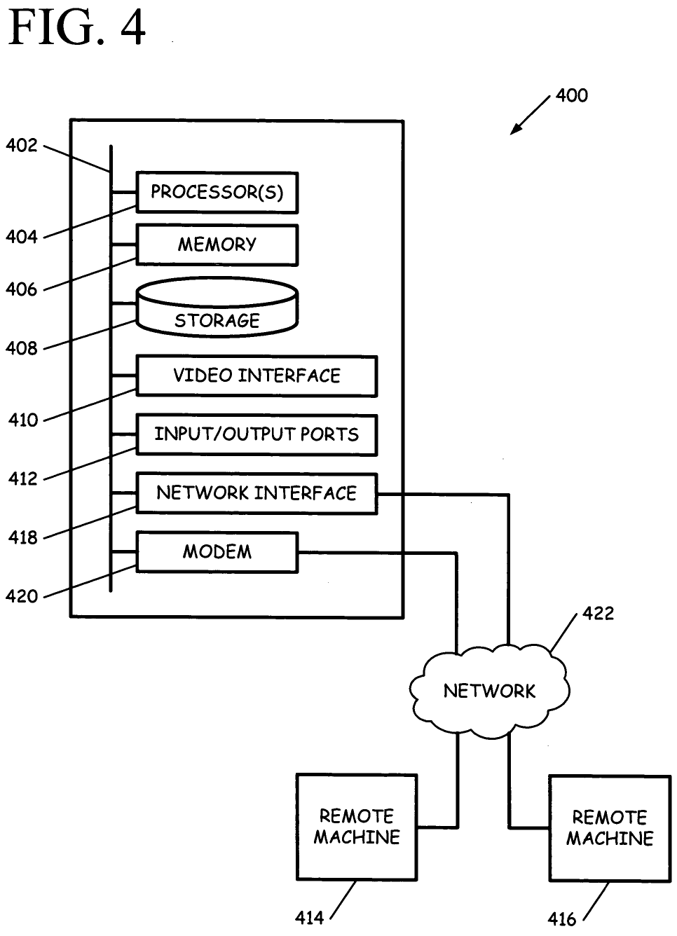

FIG. 4 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. The system of communicatively coupled machines may correspond to machines within a household or office, e.g., within a “digital home” or “digital office.” Exemplary machines include computing devices such as personal computers, workstations, servers, portable computers, handheld devices, e.g., Personal Digital Assistant (PDA), telephone, tablets, etc., as well as transportation devices, such as private or public transportation, e.g., automobiles, trains, cabs, etc., and appliances.

Typically, the environment includes a machine 400 that includes a system bus 402 to which is attached processors 404, a memory 406, e.g., random access memory (RAM), read-only memory (ROM), or other state preserving medium, storage devices 408, a video interface 410, and input/output interface ports 412. The machine may be controlled, at least in part, by input from conventional input devices, such as keyboards, mice, etc., as well as by directives received from another machine, interaction with a virtual reality (VR) environment, biometric feedback, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 414, 416, such as through a network interface 418, modem 420, or other communicative coupling. Machines may be interconnected by way of a physical and/or logical network 422, such as the network 118 of FIG. 1, the network 206 of FIG. 2, an intranet, the Internet, local area networks, wide area networks, and the like. The system of communicatively coupled machines may include any machines reachable over the various network 422 possibilities. One skilled in the art will appreciated that communication with network 422 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine and/or used in conjunction with a control program or operating system of the machine, or with built-in capabilities of the machine, results in the machine performing tasks and/or defining abstract data types or low-level hardware contexts. Associated data may be stored in, for example, volatile and/or non-volatile memory 406, or in storage devices 408 and their associated storage media, including hard-drives, floppy-disks, optical storage, tapes, flash memory, memory sticks, digital video disks, biological storage, etc. Associated data may be delivered over transmission environments, including network 422, in the form of packets, serial data, parallel data, propagated signals, etc., and may be used in a compressed or encrypted format. Associated data may be used in a distributed environment, and stored locally and/or remotely for access by single or multi-processor machines.

Thus, for example, with respect to the illustrated embodiments, assuming machine 400 embodies the machine 102 of FIG. 1, then remote machines 414, 416 may respectively be the FIG. 1 UPnP control point 120 and UPnP display device 126. It will be appreciated that remote machines 414, 416 may be configured like machine 400, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for bridging local devices attached to a local bus of a machine with a network providing services to discover and control devices attached to the network, the method comprising:
monitoring for attachment of a local device to the local bus of the machine;
determining a characteristic of the device; and
preparing an advertisement, including at least the characteristic, for a virtual device of the network corresponding to the local device.

2. The method of claim 1, further comprising:
advertising the advertisement to the network to mimic the virtual device being attached to the network.

3. The method of claim 1, further comprising:
monitoring for attachment including detecting a broadcast across the local bus indicating the attachment;
determining the characteristic including querying the local device for its properties; and
preparing the advertisement including using default values for required values, if any, not identified from querying the local device.

4. The method of claim 1 wherein the services to discover and control devices attached to the network comprises Universal Plug and Play (UPnP), and wherein the advertisement is a UPnP advertisement identifying the virtual device.

5. The method of claim 4, further comprising:
detecting removal of the local device from the local bus of the machine; and
preparing a corresponding UPnP message indicating removal of the virtual device from the network.

6. The method of claim 1 wherein the local bus comprises the Universal Serial Bus (USB).

7. The method of claim 1, further comprising:
acquiring a local bus address for the device on the local bus;
acquiring a network address for the virtual device;
receiving a request from a requestor on the network for a device description for the virtual device; and
providing the device description for the virtual device to the requestor.

8. The method of claim 7, wherein the requestor comprises a UPnP control point.

9. The method of claim 1, further comprising:
acquiring a local bus address for the device on the local bus;
acquiring a network address for the virtual device;
determining a device description for the virtual device; and
providing the device description for the virtual device to a control point.

10. The method of claim 9, wherein the control point is a UPnP control point.

11. The method of claim 1, wherein the network includes selected ones of the following data transmission mediums: wireless communication, power line communication, wire communication, microwave communication.

12. The method of claim 1, further comprising a second machine performing said monitoring for attachment, determining the characteristic, and preparing the advertisement.

13. A method for presenting devices of a local bus as self-configuring self-describing devices of a network, the method comprising:
providing a local bus of a machine supporting a first protocol for identifying characteristics of a local device communicatively coupled with the local bus;
providing a network interface to communicatively couple the machine with a network supporting a second protocol for self-configuring and self-describing devices of the network;
determining a characteristic of the device; and
creating an advertisement in accord with the second protocol corresponding to a virtual device of the network including the characteristic of the device.

14. The method of claim 13, further comprising:
receiving a command from the network in accord with the second protocol for commanding the local device; and
converting the command from the network into a corresponding command in accord with the first protocol.

15. The method of claim 13, wherein the first protocol comprises the Universal Serial Bus (USB) protocol.

16. The method of claim 13, wherein the second protocol comprises the Universal Plug and Play protocol (UPnP).

17. The method of claim 13, wherein determining the local device has been added comprises a selected one of: polling the local bus to identify newly attached devices, and monitoring the local bus to identify newly attached devices.

18. The method of claim 13, further comprising providing isochronous bandwidth between the local device and a network device of the network.

19. A system comprising:
a local bus and a local device communicatively coupled thereto;
a network and a network device communicatively coupled thereto; and
a bridge communicatively coupled with the local bus and the network, the bridge operative to receive notification of at least attachment of the local device to the local bus, receive indication of a characteristic of the local device, and advertise an attachment to the network of a virtual device having the characteristic of the local.

20. The system of claim 19, further comprising:
a control point communicatively coupled to the network for receiving and storing at least the advertisement of the local device.

21. The system of claim 19, wherein the system is disposed within a house.

22. The system of claim 19, wherein:
the local bus and the bridge are disposed in a machine having the local device coupled to the machine;
the local device produces a data stream; and
the network device receives and processes the data stream.

23. The system of claim 22, wherein the data stream comprises audio and/or video data, and wherein said processing the data stream comprises rendering said audio and/or video data.

24. An article comprising a machine-accessible media having associated data for bridging local devices attached to a local bus of a machine with a network, wherein the data, when accessed, results in a machine performing:
monitoring for attachment of a local device to the local bus of the machine;
determining a characteristic of the device; and
preparing an advertisement, including at least the characteristic, for a virtual device of the network corresponding to the local device.

25. The article of claim 24 wherein the machine-accessible media further includes data, when accessed, results in the machine performing:
advertising the advertisement to the network to mimic the virtual device being attached to the network.

26. The article of claim 24 wherein said data:
for monitoring for attachment includes data, which when accessed, results in the machine detecting a broadcast across the local bus indicating the attachment;
for determining the characteristic includes data, which when accessed, results in the machine querying the local device for its properties; and
for preparing the advertisement includes data, which when accessed, results in the machine using default values for required values, if any, not identified from said querying the local device.

27. An article comprising a machine-accessible media for a machine, the machine having
a local bus supporting a first protocol for identifying characteristics of a local device communicatively coupled with the local bus, and
a network interface to communicatively couple the machine with a network supporting a second protocol for self-configuring and self-describing devices of the network, wherein the data, when accessed, results in a machine performing:
detecting attachment of the device to the local bus;
determining a characteristic of the device after detecting attachment; and
creating an advertisement in accord with the second protocol corresponding to a virtual device of the network including the characteristic of the device.

28. The article of claim 27 wherein the machine-accessible media further includes data, when accessed, results in the machine performing:
receiving a command from the network in accord with the second protocol for commanding the local device; and
converting the command from the network into a corresponding command in accord with the first protocol.

29. An apparatus, comprising
at least one processor,
a local bus supporting a first protocol for identifying characteristics of a local device communicatively coupled with the local bus,
a network interface to communicatively couple the machine with a network supporting a second protocol for self-configuring and self-describing devices of the network, and
a processor-accessible media having data, which when accessed by selected ones of the at least one processor, results in the apparatus performing:
detecting attachment of the device to the local bus;
determining a characteristic of the device after detecting attachment; and
creating an advertisement in accord with the second protocol corresponding to a virtual device of the network including the characteristic of the device.

30. The apparatus of claim 29, wherein the processor-accessible media further includes data, when accessed by selected ones of the at least one processor, results in the apparatus performing:
receiving a command from the network in accord with the second protocol for commanding the local device; and
converting the command from the network into a corresponding command in accord with the first protocol.
